(19) United States
(12) Patent Application Publication
(10) Pub. No.: US 2026/0202983 A1
(43) Pub. Date: Jul. 16, 2026

(54) ENHANCED STATUS POLLING FOR MEMORY DEVICES

(71) Applicant: Micron Technology, Inc., Boise, ID (US)

(72) Inventors: Scott Anthony Stoller, Boise, ID (US); Brent Carl Byron, Boise, ID (US); Robert Winston Mason, Boise, ID (US)

(21) Appl. No.: 19/020,653

(22) Filed: Jan. 14, 2025

(51) Int. Cl. G06F 3/06

(52) U.S. Cl. CPC G06F 3/0653; G06F 3/0604; G06F 3/0679

(57) ABSTRACT

A memory device is polled for status information about an array operation being performed at the memory device. The status information is obtained from the memory device based on the polling. One or more polling parameters are adjusted based on the status information.

### TECHNICAL FIELD

Embodiments of the disclosure relate generally to memory sub-systems and, more specifically, to techniques for enhanced status polling of memory devices.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a memory sub-system, in accordance with some examples.

FIG. 2 is a data flow diagram illustrating interactions between components in the memory sub-system in performing enhanced status polling of a memory device, in accordance with some examples.

FIGS. 3-5 are flow diagrams illustrating example methods for performing enhanced status polling of a memory device, in accordance with some examples.

FIG. 6 is a block diagram of an example computer system in which embodiments of the present disclosure may operate.

### DETAILED DESCRIPTION

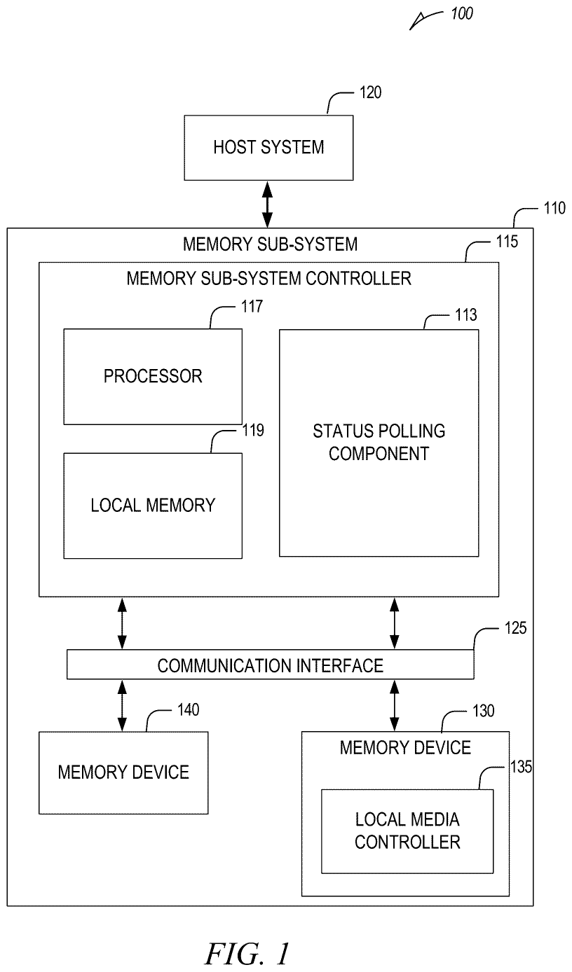

Aspects of the present disclosure are directed to an approach for enhanced status polling of a memory device in a memory sub-system. A memory sub-system can be a memory device (e.g., solid-state drive [SSD]), a memory module, or a combination of a memory device and a memory module. Examples of memory devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system. A memory sub-system controller typically receives commands or operations from the host system and converts the commands or operations into instructions or appropriate commands to achieve the desired access to the memory components of the memory sub-system.

A memory device can be a non-volatile memory device. One example of a non-volatile memory device is a negative-and (NAND) memory device. A NAND memory device can include multiple NAND dies. Each die may include one or more planes, and each plane includes multiple blocks. Each block includes an array that includes pages (rows) and strings (columns). A string includes a plurality of memory cells connected in series. A memory cell (also referred to herein simply as a “cell”) is an electronic circuit that stores information. Depending on the cell type, a cell can store one or more bits of binary information and has various logic states that correlate to the number of bits being stored. The logic states can be represented by binary values, such as “0” and “1,” or combinations of such values.

Various memory array operations can be performed on the memory cells. Data can be written to, read from, and erased from memory cells. Memory cells can be grouped into a write unit, such as a page. For some types of memory devices, a page is the smallest write unit. A page size represents a particular number of cells of a page. Data can be written to a block, page-by-page. During write operations, data is programmed into a block of the memory device using a programming sequence that includes multiple passes in which programming pulses are applied to cells in the block. Over the multiple passes, the programming pulses configure the threshold voltages (Vt) of the cells in each page according to the value that the cells are intended to represent. As the programming sequence progresses, the voltage level of the programming pulses increase until a target voltage level for each cell is reached. In some instances, memory subsystems may need to temporarily suspend ongoing operations to service other requests. The management of these suspend operations requires consideration of factors such as forward progress on the original operation and efficient resumption of suspended tasks.

Memory subsystems commonly employ status polling mechanisms to determine when array operations on memory devices are complete. Status polling involves sending operation status requests to a memory device at regular intervals, with the device responding to indicate whether it is ready or still processing an operation. Operation times in NAND memory devices can vary based on multiple factors including the specific operation being performed, device characteristics, and environmental conditions such as temperature. For example, array operation completion times may differ significantly between hot and cold temperature conditions.

Status polling presents competing considerations between latency and efficiency. Frequent polling can increase bus utilization, while infrequent polling may delay recognition of operation completion. The timing of status polling operations affects both system performance and resource utilization. Conventional memory subsystems typically implement fixed timing parameters for status polling across all operating conditions. Additionally, status information is generally limited to basic state data communicated through standard status registers.

Aspects of the present disclosure address the above and other issues with a memory sub-system that utilizes enhanced polling status techniques. A status polling component sends operation status requests to a memory device and obtains status information from a status register of the memory device. The status information is represented by multiple bits in the status register and can include an estimated time to completion of an array operation and/or operation progress information such as a current erase or programming loop count, an estimated remaining loops to completion, and an erase or programming forward progress indicator. Based on the status information, the status polling component adjusts one or more system parameters including status polling parameters, operation timing parameters, and/or power credit allocations. In an example, the status polling component may adjust a polling interval parameter or suspend operation delay parameter based on the status information. In another example, the status polling component may also release power credits incrementally based on operation progress information rather than waiting for complete operation completion.

By providing estimated completion time information through existing status register bits, the memory sub-system reduces polling overhead and optimizes subsequent polling intervals. Additionally, traditional techniques lack detailed operation progress information, requiring systems to use conservative fixed delays for suspend operations and power credit management. Enhanced status information about program and erase operations, including pulse counts and forward progress indicators, enables the memory sub-system to dynamically adjust suspend delays and incrementally release power credits. This granular operation information allows systems to maximize bus efficiency while maintaining optimal performance across varying operating conditions.

FIG. 1 illustrates an example computing environment 100 that includes a memory sub-system 110, in accordance with some embodiments of the present disclosure.

The memory sub-system 110 can include media, such as one or more volatile memory devices (e.g., memory device 140), one or more non-volatile memory devices (e.g., memory device 130), or a combination of such.

A memory sub-system 110 can be a memory device, a memory module, or a hybrid of a memory device and memory module. Examples of a memory device include an SSD, a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, and so forth.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize a Non-Volatile Memory Express (NVMe) interface to access the memory devices 130 and 140 when the memory sub-system 110 is coupled with the host system 120 by the PCIe or CXL interface. The physical host interface can provide an interface for passing control, address, data, and other signals between the memory sub-system 110 and the host system 120.

The memory devices can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

An example of non-volatile memory devices (e.g., memory device 130) includes a NAND type flash memory. Each of the memory devices 130 can include one or more arrays of memory cells such as single level cells (SLCs), multi-level cells (MLCs) (e.g., triple level cells [TLCs], or quad-level cells [QLCs]). In some embodiments, a particular memory component can include an SLC portion, and an MLC portion, a TLC portion, or a QLC portion of memory cells. Each of the memory cells can store one or more bits of data used by the host system 120. Furthermore, the memory cells of the memory devices 130 can be grouped as memory pages or memory blocks that can refer to a unit of the memory component used to store data.

Although non-volatile memory components such as NAND type flash memory are described, the memory device 130 can be based on any other type of non-volatile memory, such as read-only memory (ROM), phase change memory (PCM), magneto random access memory (MRAM), NOR flash memory, electrically erasable programmable read-only memory (EEPROM), and a cross-point array of non-volatile memory cells. A cross-point array of non-volatile memory can perform bit storage based on a change of bulk resistance in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

The memory sub-system controller 115 can communicate with the memory devices 130 to perform operations such as reading data, writing data, or erasing data at the memory devices 130 and at other such operations. For example, the memory sub-system controller 115 can be coupled to any one or more of the memory device 130 or 140 over a communication interface 125. The communication interface 125 comprises multiple channels to facilitate communication between the memory sub-system controller 115 and the memory devices 130 and 140. In an example, the memory device 130 includes multiple dies and each die of the memory device 130 uses one of the channels to communicate with the memory sub-system controller 115. That is, a given die of the memory device 130 may communicate (e.g., send and receive data and commands) with the memory sub-system controller 115 over a channel of the communication interface 125 dedicated to the die. In some examples, the communication interface 125 comprises a data transfer interface such as an Open Nand Flash Interface (ONFI) bus. In some examples, the communication interface 125 comprises a separate command-address (SCA) bus for the memory sub-system controller 115 to send commands to the memory devices 130 and 140.

The memory sub-system controller 115 can include hardware such as one or more integrated circuits and/or discrete components, a buffer memory, or a combination thereof. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, and the like. The local memory 119 can also include ROM for storing micro-code. While the example memory sub-system 110 in FIG. 1 has been illustrated as including the memory sub-system controller 115, in another embodiment of the present disclosure, a memory sub-system 110 may not include a memory sub-system controller 115, and may instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical block address and a physical block address that are associated with the memory devices 130. The memory sub-system controller 115 can further include host interface circuitry to communicate with the host system 120 via the physical host interface. The host interface circuitry can convert the commands received from the host system into command instructions to access the memory devices 130 and convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130.

The memory sub-system 110 also includes a status polling component 113 that is responsible for performing status polling of the memory device 130. In performing status polling, the status polling component 113 sends one or more commands comprising requests for status information (also referred to as “application status requests”) regarding array operations being performed at the memory device 130 to the memory device 130 via the communication interface 125. In some examples, the status polling component 113 sends the one or more commands to the memory device 130 via an ONFI bus. In some examples, the status polling component 113 sends the one or more commands to the memory device via an SCA bus. The status polling component 113 obtains status information (e.g., from a status register) based on the polling, which the status polling component 113 uses as a basis to adjusts one or more system parameters. The status information may, for example, include an estimated time to completion of an array operation and/or operation progress information such as a current erase or programming loop count, an estimated remaining loops to completion, and an erase or programming forward progress indicator.

As noted above, the status polling component 113 may adjust one or more system parameters based on the status information. In some examples, the processing device adjusts one or more status polling parameters based on the status information. In some examples, the processing device adjusts one or more timing parameters associated with array operations performed at the memory device.

In some embodiments, the memory sub-system controller 115 includes at least a portion of the status polling component 113. For example, the memory sub-system controller 115 can include a processor 117 (processing device) configured to execute instructions stored in local memory 119 (e.g., firmware) for performing the operations described herein. In some embodiments, the status polling component 113 is part of the host system 120, an application, or an operating system. Further details regarding the status polling component 113 are discussed below.

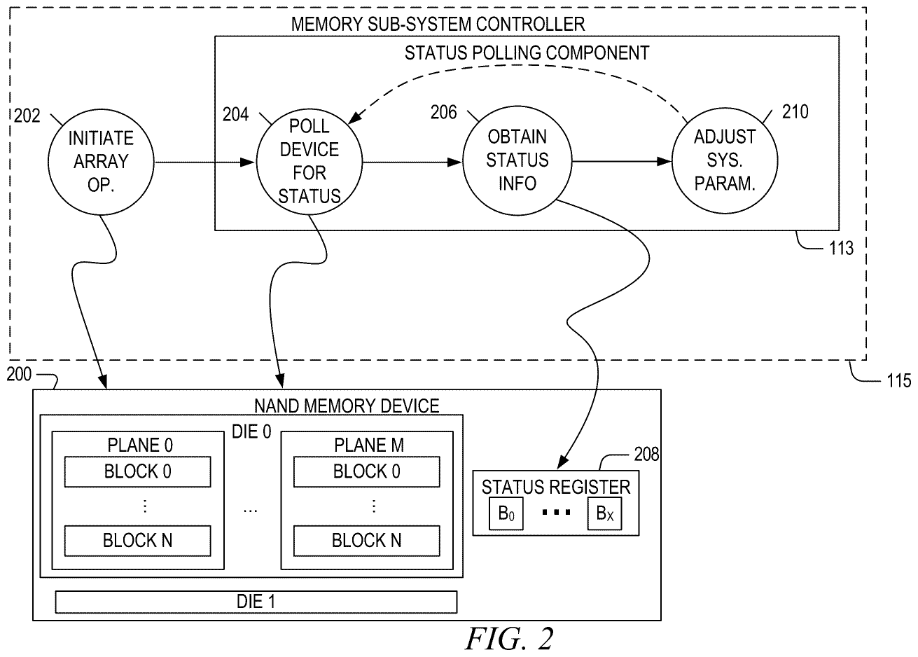

FIG. 2 is a data flow diagram illustrating interactions between components in the memory sub-system in performing enhanced status polling of a memory device, in accordance with some examples. In the example illustrated in FIG. 2, the memory device 200 is an example memory device 130 in the example form of a NAND memory device.

The memory device 200 includes multiple NAND dies. Each die may include one or more planes, and each plane includes multiple blocks such as block₀-block_{N} illustrated in FIG. 2. Each block includes a two- or three-dimensional array that includes pages (rows) and strings (columns). A string includes a plurality of memory cells connected in series. Each memory cell is used to represent one or more bit values. For example, a single NAND flash cell includes a transistor that stores an electric charge on a memory layer that is isolated by oxide insulating layers above and below. Within each cell, data is stored as the threshold voltage of the transistor. SLC NAND, for example, can store one bit per cell. Other types of memory cells, such as MLCs, TLCs, QLCs, and PLCs, can store multiple bits per cell. In this example, the NAND memory includes an SLC portion that includes multiple SLCs and a QLC portion that includes multiple QLCs.

As noted above, each NAND cell stores data in the form of the threshold voltage (V_{T}) of the transistor. The range of threshold voltages of a memory cell can be divided into a number of regions based on the number of bits stored by the cell where each region corresponds to a value that can be represented by the cell. More specifically, each region corresponds to a read voltage level (also referred to simply as “read level”) and each read voltage level decodes into a multi-bit value. For example, a TLC NAND flash cell can be at one of eight read levels (L0, L1, L2, L3,L4, L5, L6, or L7) and each read level decodes into a 3-bit value that is stored in the flash cell (e.g., 111, 110, 100, 000, 010, 011, 001, and 101).

At operation 202, the memory sub-system controller 115 initiates an array operation at the NAND memory device 200. For example, the memory sub-system controller 115 may initiate a read operation to read data from the NAND memory device 200, a programming operation to program (write) data to the NAND memory device 200, or an erase operation to erase data from the NAND memory device 200.

At operation 204, the status polling component 113 polls the NAND memory device 200 for status information associated with the array operation. In general, polling includes sending operation status requests to the NAND memory device 200. In this example, the status polling component 113 sends an initial operation status request to the NAND memory device 200 after a delay defined by an initial delay parameter and may subsequently send one or more follow-up status requests at an interval defined by a polling interval parameter, depending on the outcome of subsequent operations. In some examples, the status polling component 113 sends commands comprising operations status requests to the memory device 200 via an ONFI bus (not shown). In some examples, the status polling component 113 sends commands comprising operations status requests to the memory device 200 via an SCA bus (not shown).

Based on one or more status polling commands from the status polling component 113, the NAND memory device 200 outputs current status information to a status register 208. The status register 208 stores the status information as a series of bits with specific bits being designated for certain portions of the status information. As an example, the status information can include an indicator of an estimated time to completion of the operation and/or operation progress information such as any one or more of a loop count, an estimated remaining loops to completion, and a forward progress indicator.

In some example implementations of the status register 208, bits 0 and 1 of the status register, which are traditionally used for indicating operation failures during program and erase operations, but are not used during read operations, are used to store an estimate of time remaining. In an example, a value of 11b indicates less than 3 microseconds of busy time remaining, 10b indicates less than 2microseconds remaining, 01b indicates less than 1 microsecond remaining, and 00b indicates greater than 3 microseconds of busy time remaining. In another examples, a value of 11b is used to indicate less than 750 ns remaining, 10b is used for less than 500 ns remaining, 01b is used for less than 250 ns remaining, and 00b is used for greater than 750 ns of busy time remaining. Although the traditional fail bits can be used to represent the estimated time remaining for an operation, other status register bits can also be repurposed or added for this functionality.

The status polling component 113 accesses the status information from the status register 208, at operation 206. Depending on the size of bandwidth of the communication interface 125 and the size of the status register 208, the status polling component 113 may clock out the status information from the status register 208 in multiple clock cycles. In an example, in which the memory sub-system 110 comprises a 2-bit SCA bus for the memory sub-system controller 115 to send commands to the memory device 200 and the memory device 200 comprises an 8-bit status register 208, the status polling component 113 clocks out the status information on the SCA bus in four data output cycles.

At operation 210, the status polling component 113 adjusts one or more system parameters. The system parameters include status polling parameters, operation timing parameters, and power credit allocations. In an example, the status polling component 113 adjusts one or more polling parameters based on the status information. In adjusting the one or more polling parameters, the status polling component 113 can adjust the polling interval parameter. In some instances, the status polling component 113 adjusts the polling interval parameter such that no further follow-up operation status requests are sent to the memory device 200.

In another example, the status polling component 113 adjusts one or more operation timing parameters such as a resume-to-suspend timing parameter or suspend operation delay parameter. The status polling component 113 may adjust a resume-to-suspend timing parameter based on a forward progress indicator to prevent a programming operation from being stuck on the same programming pulse.

The processing device may adjust the suspend operation delay parameter based on a programming forward pulse progress indicator to ensure adequate time for forward progress between suspends. The suspend operation delay parameter defines a suspend delay. A suspend delay refers to a temporary pause of ongoing operations (like program operations) to service other operations (like host reads). For example, when a program operation is suspended, the memory device 200 pauses its current operation. This allows the memory device 200 to service other operations, like host reads. The challenge with suspend operations is ensuring forward progress is made on the original operation. If an operation is resumed and then suspended too quickly, the memory device 200 will not make forward progress—it can get stuck on the same programming pulse repeatedly. This creates a risk of the memory device 200 being perpetually stuck in this state if constantly suspended. To address issues, the status information includes information such as whether forward progress was made since the last suspend, how many programming pulses of forward progress occurred, where in the programming loop the operation was interrupted. This information allows the system to dynamically optimize suspend delays instead of using fixed timing parameters. For example, if the memory device 200 indicates it was interrupted during a programming pulse, it will make forward progress, but if interrupted during verify operations before another pulse, the memory device 200 will not make progress. With this operation progress information, the status polling component 113 can ensure adequate time between suspend operations while avoiding unnecessarily long fixed delays, ultimately improving both performance and reliability.

In some examples, the memory sub-system 110 uses power credits as a resource management mechanism to control and optimize power consumption. Consistent with these examples, the memory sub-system 110 maintains a pool of power credits that represents available power capacity. When performing operations like program operations, the memory sub-system 110 “checks out” power credits from this pool before executing the operation. The power credit system helps to: prevent exceeding power budgets while maximizing utilization; enable additional operations to be performed within a given time window; reduce latency excursions caused by power throttling; and allow for more efficient resource allocation.

In an example, when initiating a program operation that could take up to three programming pulses, the memory sub-system 110 checks out enough power credits to cover all potential pulses. However, the memory sub-system 110 can optimize power credit management by using status information about operation progress to determine when credits can be safely released, rather than waiting for operation completion. For example, the memory sub-system 110 can incrementally release power credits back to the pool as operations complete. That is, if a power credit is allocated to each of three programming pulses of a programming operation, and two out of three of the programming pulses are complete as indicated by the status information, the memory sub-system 110 can release two power credits, making them available for other operations.

In some examples, upon adjusting the system parameters based on status information at operation 210, the status polling component 113 returns to polling the memory device 200 for status information based on the adjusted system parameters (e.g., based on the adjusted polling parameters). For example, the status polling component 113 may send one or more operation status requests at an interval based on an adjusted polling interval parameter to the NAND memory device 200 until the NAND memory device 200 indicates that the operation is complete.

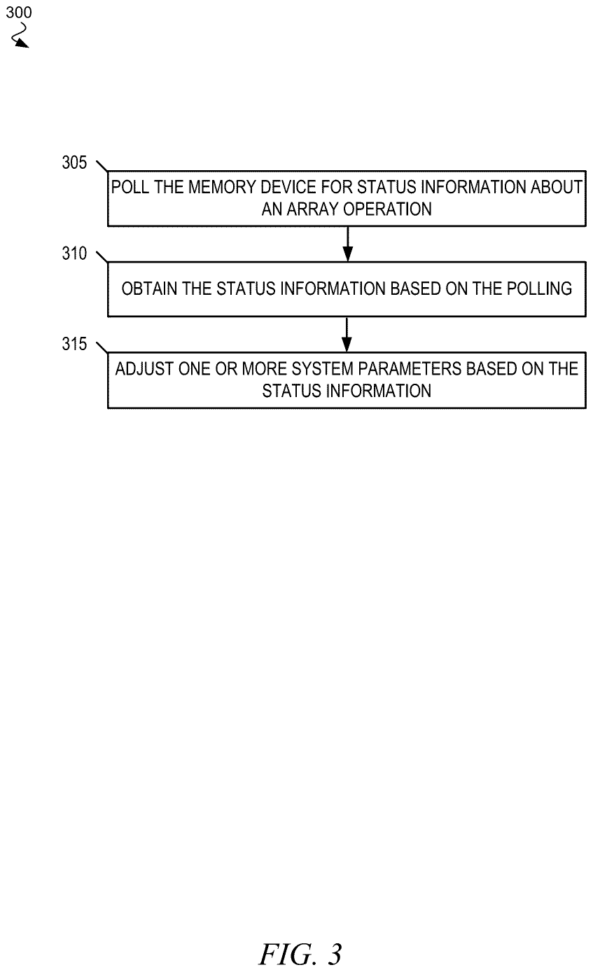

FIGS. 3-5 are flow diagrams illustrating an example method 300 for performing enhanced status polling of a memory device, in accordance with some examples. The method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 300 is performed by the status polling component 113 of FIG. 1. Although processes are shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment; other process flows are possible.

To set the context of method 300, an array operation (e.g., a read, program, or erase operation) is initiated at a memory device (e.g., the memory device 200).

At operation 305, the processing device polls the memory device for status information about the array operation. Polling generally includes sending operation status requests (e.g., in the form of commands) to the memory device.

At operation 310, the processing device obtains the status information from the memory device. In an example, the processing device accesses the status information from a status register (e.g., status register 208).

At operation 315, the processing device adjusts one or more system parameters based on the status information. In some examples, the processing device adjusts one or more status polling parameters based on the status information. In some examples, the processing device adjusts one or more timing parameters associated with array operations performed at the memory device. In some examples, the adjustment of the one or more system parameters includes releasing one or more power credits based on the status information.

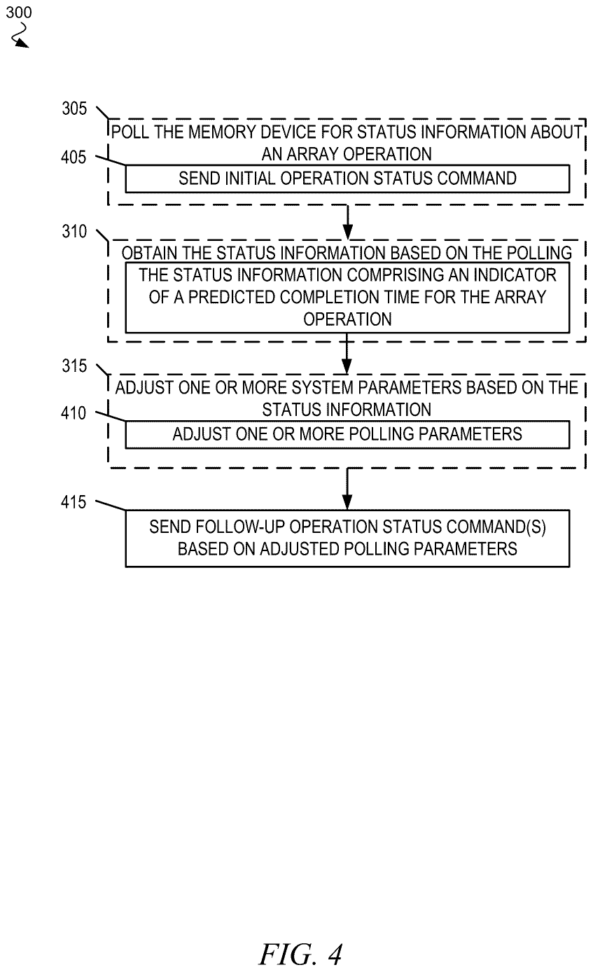

As shown in FIG. 4, in some examples the method 300 comprises operations 405, 410, and 415. Consistent with these examples, the operation 405 is performed as part of the operation 305 where the processing device polls the memory device for status information about the array operation. At operation 405, the processing device sends an initial operation status command to the memory device.

Consistent with these examples, the status information obtained by the processing device based on the initial operation status command, at operation 310, comprises an indicator of a predicted completion time of the array operation.

As shown, the operation 410 is performed as part of the operation 315 where the processing device adjusts one or more system parameters based on the status information. At operation 410, the processing device adjusts one or more polling parameters. The polling parameters comprise an initial delay parameter and a polling interval parameter. The initial delay parameter defines a delay (a first time period) between initiating the array operation at the memory device and sending the initial operation status command to the memory device. The polling interval parameter defines an interval (a second time period) between sending follow-up operation status commands. In an example, the processing device adjusts the polling interval parameter based on an indicator of estimated remaining time for the array operation included in the status information.

At operation 415, the processing device sends one or more follow-up operation status commands (comprising operation status requests) to the memory device in accordance with the adjusted polling parameters. In an example, the processing device, sends one or more follow-up operation status commands to the memory device at an interval based on an adjusted polling interval parameter. In some examples, the processing device adjusts the polling interval parameter such that no further follow-up operation status commands are sent to the memory device.

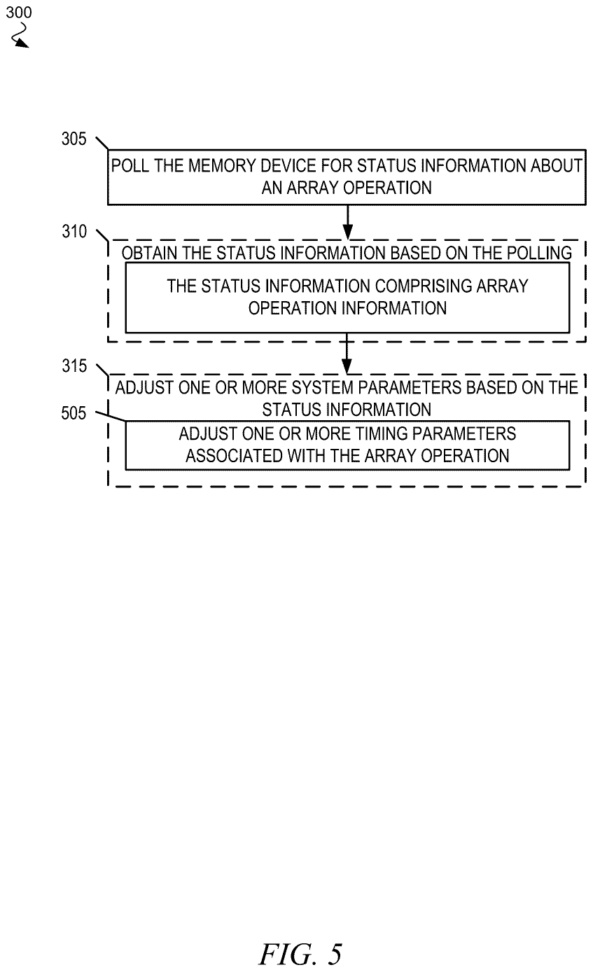

As shown in FIG. 5, the method 300 can include operation 505, in some examples. Consistent with these examples, the status information obtained at operation 310 by the processing device comprises operation feedback information about the array operation. The operation feedback information comprising one or more of: a current erase or programming loop count, an estimated remaining loops to completion, and an erase or programming forward progress indicator. Consistent with these examples, the operation 505 is performed as part of the operation 315 where the processing device adjusts one or more system parameters based on the status information.

At operation 505, the processing device adjusts one or more timing parameters associated with the array operation. In a first example, the processing device adjusts a suspend operation delay parameter based on a programming forward pulse progress to ensure adequate time for forward progress between suspends. In another example, the processing device adjusts a resume-to-suspend timing parameter based on a forward progress indicator to prevent a programming operation from being stuck on the same programming pulse.

Described implementations of the subject matter can include one or more features, alone or in combination, as illustrated below by way of example.

Example 1. A memory sub-system comprising: a memory device; a processing device, operatively coupled with the memory device, to perform operations comprising: polling the memory device for status information about an array operation being performed at the memory device; obtaining the status information from the memory device based on the polling; and adjusting one or more polling parameters based on the status information.

Example 2. The memory sub-system of Example 1, wherein the status information comprises an indicator of a predicted completion time for the array operation.

Example 3. The memory sub-system of any one or more of Examples 1 or 2, wherein polling the memory device comprises sending one or more operation status commands to the memory device.

Example 4. The memory sub-system of any one or more of Examples 1-3, wherein polling the memory device comprises sending an initial operation status command to the memory device, wherein the operations comprise sending one or more follow-up operation status commands to the memory device.

Example 5. The memory sub-system of any one or more of Examples 1-4, wherein the one or more polling parameters comprise: an initial delay parameter that defines a first time period between initiating the array operation at the memory device and sending the initial operation status command to the memory device; and a polling interval parameter that defines a second time period between sending follow-up operation status commands.

Example 6. The memory sub-system of any one or more of Examples 1-5, wherein the adjusting of the one or more polling parameters comprises adjusting a polling interval parameter, the polling interval parameter defining a time period between operation status commands.

Example 7. The memory sub-system of any one or more of Examples 1-6, wherein the adjusting of the one or more polling parameters comprises configuring a polling parameter such that no additional operation status commands are sent as part of polling to the memory device for the status information associated with the array operation.

Example 8. The memory sub-system of any one or more of Examples 1-7, wherein the status information comprises one of: a loop count, an estimated remaining loops to completion, and a forward progress indicator.

Example 9. The memory sub-system of any one or more of Examples 1-8, wherein the operations comprise adjusting a timing parameter associated with the array operation based on the status information.

Example 10. The memory sub-system of any one or more of Examples 1-9, comprising a status register to store the status information, the status information being represented by multiple bits in the status register.

Example 11. The memory sub-system of any one or more of Examples 1-10, wherein the obtaining of the status information comprises accessing the multiple bits from the status register.

Example 12. The memory sub-system of any one or more of Examples 1-11, wherein the multiple bits are accessed from the status register in multiple clock cycles.

Example 13. The memory sub-system of any one or more of Examples 1-12, comprising a communication interface to communicatively couple the processing device with the memory device, wherein the communication interface comprises at least one of an open NAND flash interface (ONFI) bus and a separate command address (SCA) bus, wherein the processing device accesses the status information from the status register via the communication interface.

Example 14. A method comprising: polling, by a processing device, a memory device for status information about an array operation being performed at the memory device; obtaining, by the processing device, the status information from a status register of the memory device based on the polling; and adjusting, by the processing device, one or more polling parameters based on the status information.

Example 15. The method of Example 14, wherein the status information comprises an indicator of a predicted completion time for the array operation, the indicator of the predicted completion time comprising multiple bits, the obtaining of the status information comprises accessing the multiple bits from the status register.

Example 16. The method of any one or more of Examples 14 or 15, wherein the adjusting the one or more polling parameters comprises adjusting a polling interval parameter based on the indicator of the predicted completion time for the array operation, the polling interval parameter defining a time period between operation status commands.

Example 17. The method of any one or more of Examples 14-16, wherein the status information comprises one of: a loop count, an estimated remaining loops to completion, and a forward progress indicator.

Example 18. The method of any one or more of Examples 14-17, wherein the operations comprise adjusting a timing parameter associated with the array operation based on the status information.

Example 19. A computer-readable storage medium comprising instructions that, when executed by a processing device, configure the processing device to perform operations comprising: polling a memory device for status information about an array operation being performed at the memory device; obtaining the status information from a status register of the memory device based on the polling; and adjusting one or more polling parameters based on the status information.

Example 20. The computer-readable storage medium of Example 19, wherein the status information comprises one of: a loop count, an estimated remaining loops to completion, and a forward progress indicator, wherein the operations comprise adjusting a timing parameter associated with the array operation based on the status information.

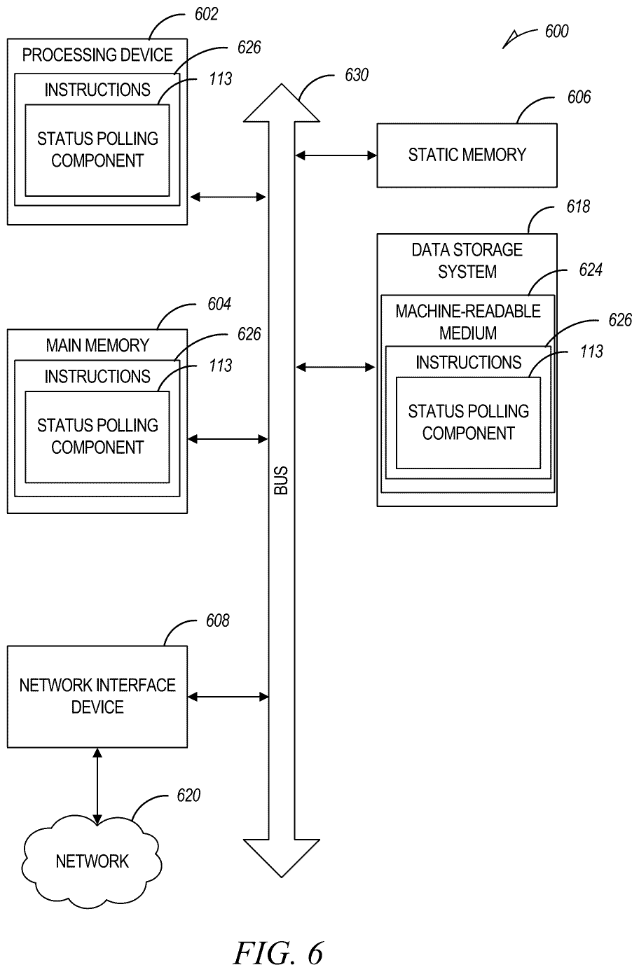

FIG. 6 illustrates an example machine in the form of a computer system within which a set of instructions can be executed for causing the machine to perform any one or more of the methodologies discussed herein. FIG. 6 illustrates an example machine of a computer system 600 within which a set of instructions, for causing the machine to perform any one or more of the methodologies discussed herein, can be executed. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the status polling component 113 of FIG. 1). In alternative embodiments, the machine can be connected (e.g., networked) to other machines in a local area network (LAN), an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., ROM, flash memory, DRAM such as SDRAM or RDRAM, etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an ASIC, a FPGA, a digital signal processor (DSP), network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to a status polling component (e.g., the status polling component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a ROM, RAM, magnetic disk storage media, optical storage media, flash memory components, etc.

In the foregoing specification, embodiments of the disclosure have been described with reference to specific example embodiments thereof. It will be evident that various modifications can be made thereto without departing from the broader scope of embodiments of the disclosure as set forth in the following claims. The specification and drawings are, accordingly, to be regarded in an illustrative sense rather than a restrictive sense.

What is claimed is:

1. A memory sub-system comprising:
a memory device;
a processing device, operatively coupled with the memory device, to perform operations comprising:
polling the memory device for status information about an array operation being performed at the memory device;
obtaining the status information from the memory device based on the polling; and
adjusting one or more polling parameters based on the status information.

2. The memory sub-system of claim 1, wherein the status information comprises an indicator of a predicted completion time for the array operation.

3. The memory sub-system of claim 1, wherein polling the memory device comprises sending one or more operation status commands to the memory device.

4. The memory sub-system of claim 1, wherein polling the memory device comprises sending an initial operation status command to the memory device, wherein the operations comprise sending one or more follow-up operation status commands to the memory device.

5. The memory sub-system of claim 4, wherein the one or more polling parameters comprise:
an initial delay parameter that defines a first time period between initiating the array operation at the memory device and sending the initial operation status command to the memory device; and
a polling interval parameter that defines a second time period between sending follow-up operation status commands.

6. The memory sub-system of claim 1, wherein the adjusting of the one or more polling parameters comprises adjusting a polling interval parameter, the polling interval parameter defining a time period between operation status commands.

7. The memory sub-system of claim 1, wherein the adjusting of the one or more polling parameters comprises configuring a polling parameter such that no additional operation status commands are sent as part of polling to the memory device for the status information associated with the array operation.

8. The memory sub-system of claim 1, wherein the status information comprises one of: a loop count, an estimated remaining loops to completion, and a forward progress indicator.

9. The memory sub-system of claim 8, wherein the operations comprise adjusting a timing parameter associated with the array operation based on the status information.

10. The memory sub-system of claim 1, comprising a status register to store the status information, the status information being represented by multiple bits in the status register.

11. The memory sub-system of claim 10, wherein the obtaining of the status information comprises accessing the multiple bits from the status register.

12. The memory sub-system of claim 11, wherein the multiple bits are accessed from the status register in multiple clock cycles.

13. The memory sub-system of claim 11, comprising a communication interface to communicatively couple the processing device with the memory device, wherein the communication interface comprises at least one of an open NAND flash interface (ONFI) bus and a separate command address (SCA) bus, wherein the processing device accesses the status information from the status register via the communication interface.

14. A method comprising:
polling, by a processing device, a memory device for status information about an array operation being performed at the memory device;
obtaining, by the processing device, the status information from a status register of the memory device based on the polling; and
adjusting, by the processing device, one or more polling parameters based on the status information.

15. The method of claim 14, wherein the status information comprises an indicator of a predicted completion time for the array operation, the indicator of the predicted completion time comprising multiple bits, the obtaining of the status information comprises accessing the multiple bits from the status register.

16. The method of claim 15, wherein the adjusting the one or more polling parameters comprises adjusting a polling interval parameter based on the indicator of the predicted completion time for the array operation, the polling interval parameter defining a time period between operation status commands.

17. The method of claim 14, wherein the status information comprises one of: a loop count, an estimated remaining loops to completion, and a forward progress indicator.

18. The method of claim 17, wherein the operations comprise adjusting a timing parameter associated with the array operation based on the status information.

19. A computer-readable storage medium comprising instructions that, when executed by a processing device, configure the processing device to perform operations comprising:
polling a memory device for status information about an array operation being performed at the memory device;
obtaining the status information from a status register of the memory device based on the polling; and
adjusting one or more polling parameters based on the status information.

20. The computer-readable storage medium of claim 19, wherein the status information comprises one of: a loop count, an estimated remaining loops to completion, and a forward progress indicator, wherein the operations comprise adjusting a timing parameter associated with the array operation based on the status information.
